(19) United States
(12) Patent Application Publication
(10) Pub. No.: US 2016/0323325 A1
(43) Pub. Date: Nov. 3, 2016

(54) METHOD AND NETWORK ELEMENT FOR PROVIDING CORE NETWORK SERVICE FOR THIRD-PARTY USER

(71) Applicant: ALCATEL LUCENT, Boulogne Billancourt (FR)

(72) Inventors: Fei Nie, Shanghai (CN); Chunlei Wang, Shanghai (CN)

(73) Assignee: Alcatel Lucent, Boulogne Billancourt (FR)

(21) Appl. No.: 15/109,209

(22) PCT Filed: Dec. 29, 2014
(86) PCT No.: PCT/IB2014/003163

§ 371 Date: Jun. 30, 2016

(30) Foreign Application Priority Data
Jan. 8, 2014 (CN) 201410007828.X

(51) Int. Cl. H04L 29/06; H04W 12/06

(52) U.S. Cl. CPC H04L 65/1016; H04W 12/06; H04L 65/1073

(57) ABSTRACT

A method for providing a core network service for a user of a third-party service provider is provided, where the method comprises: receiving, when the user of the third-party service provider logins a core network with a third-party ID, from the third-party service provider the third-party ID and a temporary core network ID assigned to the user for registration; storing the third-party ID and mapping the third-party ID to the temporary core network ID in the core network; and confirming the successful registration of the third-party ID to the user. The method further comprises: upon the successful registration of the third-party ID, the user may originate a call with the third-party ID as an origination ID or a termination ID, and the core network may carry out a billing and a call tracing associated with the third-party ID.

### BACKGROUND

The present invention relates to the field of communication, and more particularly, to a method and a network element for providing login in a core network for a user of a third-party service provider.

IP multimedia subsystem (IMS) is an inter-connected IP core network, which is independent of an access network. A Server Border Controller (SBC) provides different types of access support such as wired access, wireless access. A user may have multiple types of devices to be connected, for example, a mobile phone, a softphone and a browser. In addition, the user also needs to be connected to a plurality of telecom service providers and a plurality of Over The Tops (OTTs).

Therefore, it is required for the IMS and the SBC to serve other device providers' devices. Roaming is a method requiring a protocol between different device providers and a unique user identification. However, the method has limitations since we have more portable devices like softphone and browser. It is impossible to add the unique user identification for each of them. Web Real-Time Communication (WebRTC) and browser introduced by Hypertext Markup Language 5 (HTML5) are capable of supporting real-time communication, for example, audio and video communications. It is desired to provide a Single Sign On (SSO) function for WebRTC users. Therefore, the user expects to connect to an IMS network without a separate static IMS user identification, and enjoy the advanced services from the IMS network.

Token-based third-party authentication is a way to support the SSO. FIG. 1 shows a high level register flow for WebRTC client.

In step 101, a Web browser logins a third-party Web Server and succeeds in authentication with a third-party authentication server. The Web browser also extracts a token and temporary IMS ID (including a public ID and a private ID) generated by the third-party authentication server.

In step 102, the Web browser establishes a Web Socket connection and sends a REGISTER message including the SSO token and the temporary IMS ID obtained in step 101.

In step 103, SBC detects the SSO token and initializes an open authentication interface, where a protocol of the interface may be LDAP, HTTP, etc. Then the SBC sends an authentication request and obtains an authentication response.

In step 104, if the authentication succeeds, the SBC proxies a REGISTER to an IMS core network.

In step 105, the IMS core network implements an IMS standard authentication. If the authentication succeeds, 200 OK is sent back to the Web browser via the SBC.

There are issues in the existing token-based third-party authentication as follows:

The IMS ID is assigned to the IMS user only. For the users of the third-party service provider, they do not actually care about or need to know the temporary IMS IDs assigned to them, and they only know the ID which is assigned by the third-party service provider (a third-party ID). In addition, it is not easy to manage the temporary IMS ID since it is reusable and disclosed to the client. Some malicious clients may use the temporary IMS ID for connection which is not easy to be traced, since the temporary IMS ID is not static for any user.

As shown in the following steps 107 and 109 in FIG. 1, only the temporary IMS ID (Public ID) can be used as an origination source and a termination destination. If one wants to originate calling/dialling the third-party ID, it is always failed because the third-party ID is never registered in the IMS domain.

The users of the third-party service provider do not like to use the temporary IMS ID, since the used temporary IMS ID is different for different login processes. A major target for the SSO is to remove different IDs/passwords of the users to make it more convenient, but when a call is originated/terminated to the other, the temporary IMS ID may still be used, which is obviously inconvenient.

There is another confusion about calling ID/called ID. In the IMS domain, only the temporary IMS ID is used and delivered to the client side. Therefore, the calling ID/called ID can be only displayed as the temporary IMS ID, which is meaningless to the client side. From a user's perspective, they want to call/be called with their third-party IDs, because the third-party ID is the ID they actually care about.

There exist some other problems if the third-party ID is unknown in the IMS domain, for example, billing which is based on the IMS ID. But now in this case, the billing may be only based on the temporary IMS ID and unrelated to the third-party ID. From the perspective of call interception, it is also inconvenient to trace the temporary IMS ID, since there is no information of a mapping between the temporary IMS ID and the third-party ID within the IMS domain.

It is a new task to support the token-based third-party authentication. Based on Alcatel-Lucent (ALU) experience to support the SSO in VzW BOT project, SIP software client should be configured with the temporary IMS ID. In WebRTC Open Authentication, the WebRTC browser has to be configured with a temporary IMS Public ID which is one kind of IMS ID.

It is still at an early stage to allow the open authentication for the user of the third-party service provider. Currently, there is no detailed standard or solution about how to coordinate the third-party ID with the temporary IMS ID for scenarios like the calling/called ID display.

In summary, there is not yet a specific solution on how to provide an open IMS service for the third-party service provider. The SSO is a first step of registering the user of the third-party service provider in the IMS domain, but it still does not solve the problem of how to manage the third-party ID and the temporary IMS ID, and the user must use the temporary IMS ID as the origination/termination ID, which is very inconvenient. The present invention is to solve or alleviate the above issues.

### SUMMARY

A basic idea of the present invention is to coordinate third-party ID and temporary IMS ID in the IMS domain. When a user of a third-party service provider is registered in the IMS domain by means of the SSO, an alias ID is generated and associated with a temporary Public ID according to a mechanism of the present invention. The alias ID is not linked to the temporary IMS Public ID in case of client deregistration or registration time out.

According to one aspect of the present invention, there is provided a method for providing a core network service for a user of a third-party service provider comprising: receiving, when the user of the third-party service provider logins the core network with a third-party ID, from the third-party service provider the third-party ID and a temporary core network ID assigned to the user for registration; storing the third-party ID and mapping the third-party ID to the temporary core network ID in the core network; and confirming the successful registration of the third-party ID to the user.

In an embodiment of the present invention, storing the third-party ID includes adding an alias ID as the third-party ID.

In an embodiment of the present invention, the core network is an IP Multimedia Subsystem (IMS) network, and the temporary core network ID is a temporary IMS Public ID.

According to an embodiment of the present invention, upon the successful registration of the third-party ID, when receiving a call from the user with the third-party ID as an origination ID or a termination ID, the third-party ID is searched for in the core network, and a calling service is provided for the user according to the temporary core network ID mapped to the third-party ID.

According to an embodiment of the present invention, upon the successful registration of the third-party ID, when receiving a billing request including the third-party ID, the third-party ID is searched for in the core network, and detailed billing information is provided for the third-party service provider.

According to an embodiment of the present invention, upon the successful registration of the third-party ID, when intercepting the call including the third-party ID, the third-party ID is traced in the core network.

According to another aspect of the present invention, there is provided a network element for providing a core network service for a user of a third-party service provider, comprising: a receiving module configured to receive, when the user of the third-party service provider logins a core network with a third-party ID, from the third-party service provider the third-party ID and a temporary core network ID assigned to the user for registration; a storing and mapping module configured to store the third-party ID and map the third-party ID to the temporary core network ID in the core network; and a confirming module configured to confirm the successful registration of the third-party ID to the user.

According to an embodiment of the present invention, the storing and mapping module is further configured to store the third-party ID by adding an alias ID as the third-party ID.

According to an embodiment of the present invention, the network element further comprises a searching module configured to search for the third-party ID in the core network and provide a calling service for the user according to the temporary core network ID mapped to the third-party ID, when receiving a call from the user with the third-party ID as an origination ID or a termination ID, upon the successful registration of the third-party ID.

According to an embodiment of the present invention, the network element further comprises a billing module configured to search for the third-party ID in the core network and provide detailed billing information for the third-party service provider when receiving a billing request including the third-party ID.

According to an embodiment of the present invention, the network element further comprises a tracing module configured to trace the third-party ID in the core network when intercepting the call including the third-party ID.

The solution of the present invention can solve all the above-mentioned problems in the prior art. Because the third-party ID is registered in the IMS network, the call originated from the third-party ID or to the third-party ID is allowed. The calling ID/called ID can be displayed as the third-party ID. The billing can contain the billings for both the third-party ID and the temporary IMS ID. For the call interception, it would be possible to directly trace the third-party ID.

### BRIEF DESCRIPTION OF THE SEVERAL VIEWS OF THE DRAWINGS

A complete understanding of the present invention may be acquired by referring to the following detailed description and drawings. In the description and drawings, like reference numbers indicate like elements. The description and drawings are only illustrative rather than a limitation to the invention, and wherein:

FIG. 1 shows a schematic diagram of a message flow of a token-based third-party authentication in the prior art;

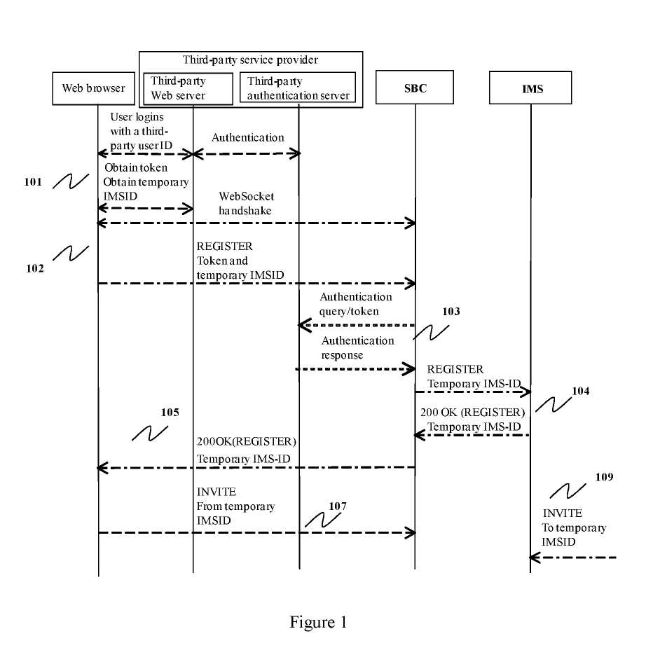

FIG. 2 shows a schematic diagram of a message flow of logining with a third-party ID according to an embodiment of the present invention; and

FIG. 3 shows a schematic diagram of a message flow with a third-party ID as a calling ID and a called ID respectively, according to an embodiment of the present invention.

### DETAILED DESCRIPTION

Various exemplary embodiments will now be fully described with reference to the accompanying drawings, and some exemplary embodiments are shown in the accompanying drawings. Specific structure or function details disclosed herein are only exemplary for describing the exemplary embodiments.

Correspondingly, although the exemplary embodiments can be modified in different ways or adopt alternative forms, the embodiments thereof are shown in the accompanying drawings as examples and will be described in detail herein. However, it should be understood that, it is not intended to limit the exemplary embodiments to the specific forms disclosed. Instead, the exemplary embodiments may cover all modifications, equivalents and alternative items.

The terminology used herein is intended to describe particular embodiments only but not limit the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be also noted that, in some alternative implementations, the noted function/action may occur out of the order noted in the figures. For example, two successive blocks may, in fact, be executed substantially concurrently, or the blocks may sometimes be executed in the reverse order, depending upon the function/action involved.

Specific details are provided in the following, in order to provide a complete understanding of the exemplary embodiments. However, those skilled in the art should understand that the exemplary embodiments can be implemented in a case without these specific details. For example, a system and a network may be shown in a block diagram, so as not to render the exemplary embodiments obscure due to unnecessary details. In other cases, in order to avoid making the exemplary embodiments obscure, the well-known processes, structures and techniques may be shown and/or discussed without unnecessary details.

The exemplary embodiments may be described as the processes shown as flow charts, flow diagrams, data flow diagrams, structural diagrams, signal flow diagrams or block diagrams. Although the signal flow diagrams may describe the operations or the interactions as sequential processes, but many operations can be implemented concurrently, simultaneously or in parallel. In addition, the order of operations or interactions can be rearranged. The process may be terminated when its operations are completed, but there may be additional steps which are not included in the drawings. The processes may correspond to methods, functions, procedures, subroutines, subprograms, etc. When the process corresponds to a function, the termination thereof may correspond to a return of the function to a calling function or a main function.

The exemplary embodiments will be described with reference to the action operations and symbolic representations (e.g., in the form of the signal flow diagrams), wherein the operations may be implemented as a program module or a function procedure, and the program module or the function procedure includes routines, programs, objects, components, data structures, etc. which implement specific tasks or implement specific abstract data types, and the operations may be implemented by existing hardware at the existing network elements or control nodes (e.g., network nodes or servers of a mesh network). The existing hardware may include one or more central processing units (CPUs), digital signal processors (DSPs), application-specific integrated circuits, and field-programmable gate array (FPGA) computers, etc.

It should also be noted that, aspects of the exemplary embodiments implemented by software are typically encoded in some form of programmable or computer-readable storage medium. The storage medium may be magnetic (e.g., a floppy disk or a hard disk) or optical (e.g., a “CD-ROM”), and may be read only or random access. The exemplary embodiments are not limited by these implementation aspects given arbitrarily.

Hereinafter, the specific examples of how to create an alias ID and associate the alias ID with a temporary Public ID of a third-party ID will be described.

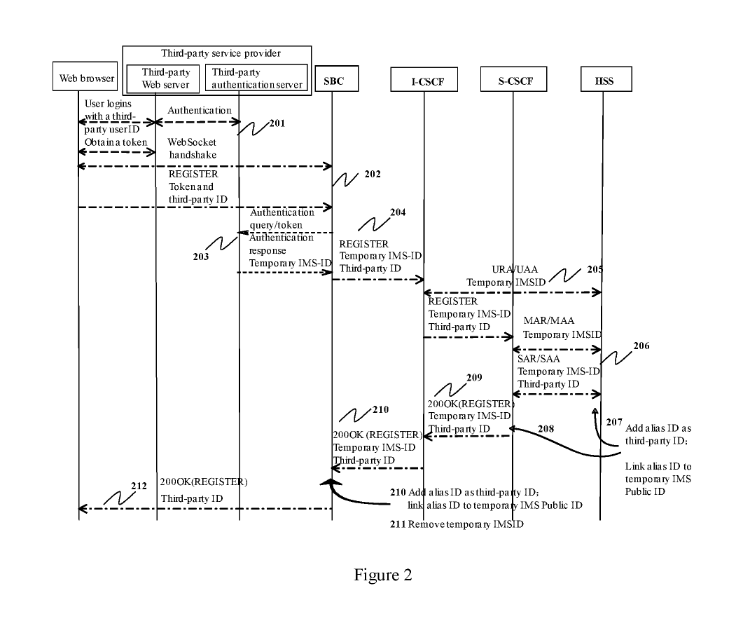

FIG. 2 shows a schematic diagram of a message flow of logining with a third-party ID according to an embodiment of the present invention.

As shown in FIG. 2, in step 201, Web browser logins in third-party Web server and succeeds in the authentication with a third-party authentication server. The browser extracts a token generated by the third-party authentication server. In this step, it is not necessary to send the temporary IMS ID to the Web browser.

In step 202, the Web browser establishes a Web Socket connection and sends a REGISTER message including SSO token obtained in step 201.

In step 203, SBC detects the SSO token and initiates an open authentication interface. The open authentication interface may use LDAP, HTTP, etc. Then the SBC sends an authentication request and obtains an authentication response which also includes the temporary IMS ID.

In step 204, if the authentication succeeds, the SBC updates the REGISTER message to add the temporary IMS ID obtained in step 203. Then the SBC sends the REGISTER message to the IMS core network.

As shown in step 205, IMS I-CSCF exchanges UAR/UAA to the HSS with the temporary IMS Public ID to query the ID existence according to a standard procedure. Since the query input is the temporary IMS Public ID, it should be successfully performed as in the existing standard.

As shown in step 206, the IMS S-CSCF exchanges MAR/MAA to the HSS with the temporary IMS Public ID and a temporary IMS Private ID according to the standard procedure. Since the query input is the temporary IMS Public ID, it should be successfully performed as in the existing standard.

In step 207, the IMS S-CSCF adds an “Alias ID” as the third-party ID in a server assignment request (SAR) to query a service profile of the user. When the HSS receives the SAR with the “Alias ID”, it stores the third-party ID as the alias ID and adds the third-party ID and the temporary IMS Public ID into Implicit Registration Set (IRS). After that, the third-party ID is similar to a normal IMS Public ID from the perspective of the HSS.

In step 208, the IMS S-CSCF receives SAA, which includes both the third-party ID as the “Alias ID” and the temporary IMS Public ID. The IMS S-CSCF also adds the third-party ID and the temporary IMS Public ID into the user's IRS. After that, the third-party ID is similar to the normal IMS Public ID from the perspective of the IMS S-CSCF.

In step 209, the IMS generates 200 OK REGISTER including the third-party ID and the temporary IMS ID and sends the 200 OK REGISTER to I-CSCF, and then the I-CSCF proxies the 200 OK REGISTER to the SBC.

In step 210, after the SBC receives the 200 OK REGISTER including the third-party ID and the temporary IMS ID, it adds the third-party ID and the temporary IMS Public ID into the user's IRS. After that, the third-party ID is similar to the normal IMS Public ID from the perspective of the SBC.

As shown in step 211, the SBC removes the temporary IMS Public ID from the 200 OK REGISTER and then proxies the 200 OK REGISTER message to the Web browser.

As shown in step 212, the Web browser receives the 200 OK REGISTER message including the third-party ID of the Web browser.

After the above-mentioned procedure, the third-party ID is registered as the “Alias ID” in the IMS domain. Accordingly, the third-party ID becomes the normal IMS ID, and the third-party ID can be the origination ID of a call or the termination ID of a call.

The above-mentioned procedure can be applied to RE-REGISTER process. The only difference is that the third-party ID is already added, and only some verification needs to be made.

The above-mentioned procedure can be applied to DE-REGISTER process. The difference is that the HSS should remove the “Alias ID” by deregistering the SAR and unlink the “Alias ID” and the IMS Public ID, and the IMS S-CSCF and the SBC should remove the “Alias ID” by deregistering the SAR and unlink the “Alias ID” and other IMS Public IDs. Thereafter, the HSS, IMS S-CSCF and P-CSCF are all ready to coordinate another “Alias ID” on the previous temporary IMS IDs.

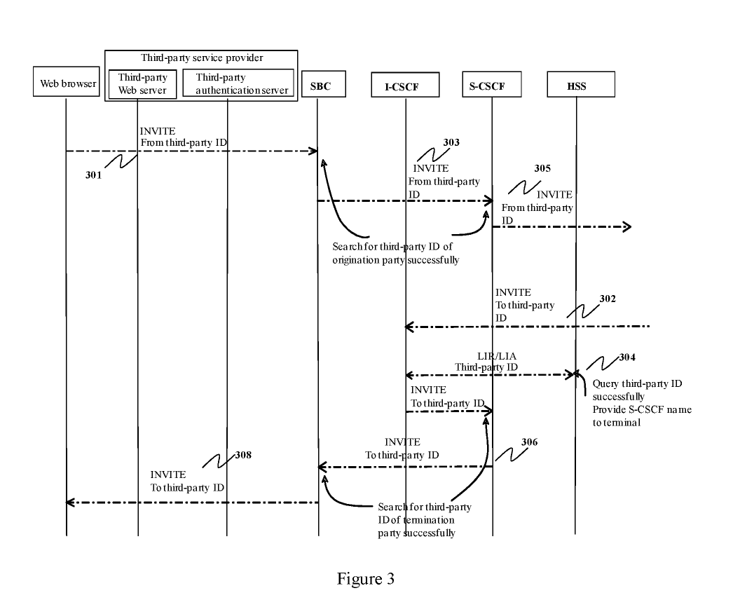

FIG. 3 shows a schematic diagram of a message flow with the third-party ID as calling ID and called ID respectively, according to an embodiment of the present invention.

In the previous registration procedure, the third-party ID has been added into the HSS, the IMS S-CSCF and the SBC as the “Alias ID” and linked to the temporary IMS Public ID within the IRS. Therefore, the third-party ID is the known ID from the perspective of the IMS. Thus, for the call origination procedure where the third-party ID is taken as the origination ID (the calling ID), as schematically shown in steps 301, 303 and 305, the third-party ID can be searched for successfully at the SBC, IMS S-CSCF and HSS. The IMS network may provide service for the user according to the temporary IMS Public ID mapped to the third-party ID. Likewise, for the call where the third-party ID is taken as the termination ID (the called ID), the third-party ID can be searched for successfully at the HSS, IMS S-CSCF and SBC. The IMS network will provide service for the user according to the temporary IMS Public ID mapped to the third-party ID. However, from the user's perspective, it is not known that the temporary IMS ID have been assigned in the IMS domain, and it is more friendly to users because they only need to know their own third-party IDs.

Because the client can use the third-party ID as the calling ID and the called ID, and there is no component to change the ID in the flows, the client is able to obtain the correct calling ID and called ID.

For the perspective of billing, both the IMS ID and the “Alias ID”/third-party ID can be added into records. Therefore, the IMS server can provide detailed billing records for the third-party service provider. For the call interception, both the third-party ID and the IMS Public ID are traceable because they are both registered. In addition, it is more convenient to trace via the third-party ID.

The above-mentioned examples focus on the IMS domain, but the method can be extended to other systems which can coordinate the third-party ID and provide seamless service.

Other embodiments of the present invention relate to a network element for providing a core network service for a user of a third-party service provider, for example, the network element in the IMS network. In the embodiments described with reference to FIGS. 2, 3, such the network element, for example, comprises part or all of the functions of at least one of SBC, I-CSCF, S-CSCF and HSS.

The mechanisms of the present invention may be implemented by software, hardware or a combination thereof, those skilled in the art should understand that the network element described herein is not necessarily a single physical device, it may be either a single physical device or multiple logical units located on a physical entity or distributed in a plurality of different physical entities.

From the above understanding, a device for providing a core network service for a user of a third-party service provider comprises the following functional modules, for example:

a receiving module configured to receive, when the user of the third-party service provider logins in the core network with the third-party ID, from the third-party service provider the third-party ID and the temporary core network ID assigned to the user for registration;

a storing and mapping module configured to store the third-party ID and map the third-party ID to the temporary core network ID such as a temporary IMS Public ID in the core network such as an IMS network; and

a confirming module configured to confirm the successful registration of the third-party ID to the user of the third-party service provider.

In an embodiment of the present invention, the storing and mapping module may be configured to store the third-party ID by adding an alias ID as the third-party ID.

In an embodiment of the present invention, the network element further comprises a searching module configured to search for the third-party ID in the core network, and provide call service for the user according to the temporary core network ID mapped to the third-party ID, when receiving a call from the user with the third-party ID as an origination ID or a termination ID upon the successful registration of the third-party ID. Such the searching module can be implemented by providing a searching function according to the present invention for the existing network element.

In an embodiment of the present invention, the network element may further comprise a billing module configured to search for the third-party ID in the core network (e.g., the IMS network) and provide detailed billing information for the third-party service provider when receiving a billing request including the third-party ID. Likewise, such the billing module can be implemented by providing the searching function according to the present invention for the existing network element.

In an embodiment of the present invention, the network element may further comprise a tracing module configured to trace the third-party ID in the core network when intercepting the call including the third-party ID.

With the mechanism of the present invention, the user of the third-party service provider can not only register in the IMS domain with SSO, but also originate/terminate a call with the third-party ID. There is no necessary to disclose the temporary IMS ID to the client. And the solution of the present invention also solves the current issues about calling/called ID, billing and call interception.

The present invention is benefit in opening IMS service to the third-party service provider, which can attract more users to the IMS domain and share the IMS service. The method of the present invention can help the IMS service provider attract more users from other device providers such as OTT.

The present invention is described; however, it will be apparent that the present invention can be varied in many modes. The variations should not be considered departing from the present invention, and all such modifications are intended to be included within the scope of the present invention.

1. A method for providing a core network service for a user of a third-party service provider, comprising:
receiving, when the user of the third-party service provider logins a core network with a third-party ID, from the third-party service provider the third-party ID and a temporary core network ID assigned to the user for registration;
storing the third-party ID and mapping the third-party ID to the temporary core network ID in the core network; and
confirming the successful registration of the third-party ID to the user.

2. The method according to claim 1, wherein storing the third-party ID comprises adding an alias ID as the third-party ID.

3. The method according to claim 1, wherein the core network is an IP Multimedia Subsystem (IMS) network, and the temporary core network ID is a temporary IMS Public ID.

4. The method according to claim 1, further comprising: searching for the third-party ID in the core network and providing a call service for the user according to the temporary core network ID mapped to the third-party ID, when receiving a call from the user with the third-party ID as an origination ID or a termination ID upon the successful registration of the third-party ID.

5. The method according to claim 1, further comprising: searching for the third-party ID in the core network and providing detailed billing information for the third-party service provider, when receiving a billing request including the third-party ID upon the successful registration of the third-party ID.

6. The method according to claim 1, further comprising: tracing the third-party ID in the core network, when intercepting a call including the third-party ID upon the successful registration of the third-party ID.

7. A network element for providing a core network service for a user of a third-party service provider, comprising:
a receiving module configured to receive, when the user of the third-party service provider logins a core network with a third-party ID, from the third-party service provider the third-party ID and a temporary core network ID assigned to the user for registration;
a storing and mapping module configured to store the third-party ID and map the third-party ID to the temporary core network ID in the core network; and
a confirming module configured to confirm the successful registration of the third-party ID to the user.

8. The network element according to claim 7, wherein the storing and mapping module is further configured to store the third-party ID by adding an alias ID as the third-party ID.

9. The network element according to claim 7, wherein the core network is an IP Multimedia Subsystem (IMS) network, and the temporary core network ID is a temporary IMS Public ID.

10. The network element according to claim 7, further comprising a searching module configured to search for the third-party ID in the core network and provide a calling service for the user according to the temporary core network ID mapped to the third-party ID, when receiving a call from the user with the third-party ID as an origination ID or a termination ID upon the successful registration of the third-party ID.

11. The network element according to claim 7, further comprising a billing module configured to search for the third-party ID in the core network and provide detailed billing information for the third-party service provider when receiving a billing request including the third-party ID.

12. The network element according to claim 7, further comprising a tracing module configured to trace the third-party ID in the core network when intercepting the call comprising the third-party ID.
